(19) United States
(12) Patent Application Publication
(10) Pub. No.: US 2025/0167505 A1
(43) Pub. Date: May 22, 2025

(54) MULTI-FEL PHOTON SOURCE

(71) Applicant: Yuhong ZHANG, Newport News, VA (US)

(72) Inventor: Yuhong ZHANG, Newport News, VA (US)

(73) Assignee: Jefferson Science Associates, LLC, Newport News, VA (US)

(21) Appl. No.: 18/513,927

(22) Filed: Nov. 20, 2023

Related U.S. Application Data
(60) Provisional application No. 63/409,252, filed on Sep. 23, 2022.

(51) Int. Cl. H01S 3/09; H01S 3/00

(52) U.S. Cl. CPC H01S 3/0903; H01S 3/0071

(57) ABSTRACT

An apparatus and method for efficient and economic production of multiple free electron lasers includes a serial arrangement of multiple FEL oscillators along a line or a closed ring and reuse of a single electron beam multiple times to drive all FEL oscillators. In a ring configuration, electron bunch recirculation in the ring could also be combined with reuse of the electron beam for FEL production. This would lead to performance enhancement as current of the electron beam would be boosted by a factor of the number of FEL oscillators thereby multiplying the amount of bunch recirculation in the ring and leading to multiple times higher photon flux/average brightness. The invention can also be applied for hybrid photon sources of both FEL and incoherent synchrotron radiation, driven by one electron beam.

This application claims the priority of Provisional U.S. Patent Application Ser. No. 63/409,252 filed Sep. 23, 2022, the entire contents of which are incorporated herein by reference.

The United States Government may have certain rights to this invention under Management and Operating Contract No. DE-AC05-06OR23177 from the Department of Energy.

### BACKGROUND OF THE INVENTION

A free electron laser (FEL) utilizes a high brightness electron beam passing through a magnetic undulator to generate high brightness coherent radiations. As shown in FIG. 1, in the current state of the art the production of multiple FEL beamlines includes generating an electron beam with an electron injector 1 and an electron accelerator 2. The electron beam, comprised of electron bunches 3, is then split by a beam spreader 4 into multiple beams. Each of the resulting beams is then fed into an FEL oscillator (FELO) 5 to generate separate free electron lasers 6. A beam dump 7 then captures and dissipates the beam energy.

Such sharing of a driving electron beam by multiple FEL drivers causes a substantial reduction of average electron beam current and power to the individual undulators, resulting in substantially lower performance in laser intensity or/and lower pulse repetition rate. It also sets a practical limit on the number of FEL beamlines in a facility.

Accordingly, it is desirable in a multi-user FEL facility to maintain a high average electron beam current and high power to individual undulators, resulting in substantially higher performance in laser intensity or/and a higher pulse repetition rate. The present invention provides a solution for increasing the number of FEL beamlines while preserving and enhancing the quality (namely peak and average brightness and pulse repetition rate) of individual FELs, while substantially reducing the construction and operating costs for a FEL-based photon sources.

### BRIEF SUMMARY OF THE INVENTION

The invention is an apparatus and method for efficient and economic production of multiple free electron lasers, including a serial arrangement of multiple FEL oscillators along a line or a closed ring and reuse of a single electron beam multiple times to drive all FEL oscillators. In a ring configuration, electron bunch recirculation in the ring could also be combined with reuse of the electron beam for FEL production. This would lead to performance enhancement as the current of the electron beam would be boosted by a factor of the number of FEL oscillators thereby multiplying the amount of bunch recirculation in the ring and leading to multiple times higher photon flux/average brightness. The invention can also be applied for hybrid photon sources of both FEL and incoherent synchrotron radiation, driven by one electron beam.

### BRIEF DESCRIPTION OF THE SEVERAL VIEWS OF THE DRAWING(S)

Reference is made herein to the accompanying drawings, which are not necessarily drawn to scale, and wherein:

FIG. 1 depicts layout of a conventional multi-FEL photon source with a parallel arrangement of FEL devices. An electron beam from an accelerator is split for single use to drive multiple undulators for creating FELs, thereby limiting average beam current and repetition frequency available to the parallel FEL devices.

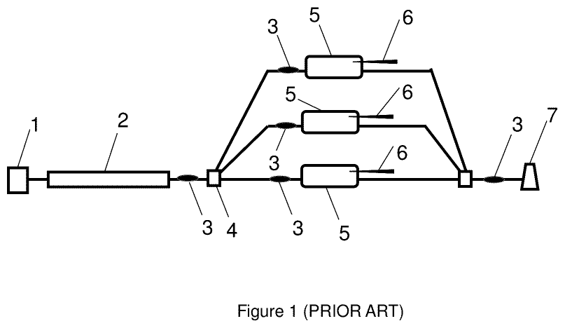

FIG. 2 is a schematic of a highly efficient multi-FEL facility according to the invention including a single high brightness electron beam driving multiple FEL oscillators arranged in a serial form.

FIG. 3 is a schematic of an FEL oscillator (FELO), a group of such devices can be arranged in serial form according to the current invention.

FIG. 4 shows a schematic of a multi-FEL facility based on this invention, with multiple FEL oscillators distributed over a closed ring, an electron beam passes through them single or multiple times to generate one FEL beamline at each of these oscillators.

FIG. 5 depicts an advanced hybrid photon source facility which includes multi FEL oscillators plus a number of incoherent synchrotron radiation beamlines, all of them are distributed in a ring and driven by one high brightness electron beam.

### DETAILED DESCRIPTION OF THE INVENTION

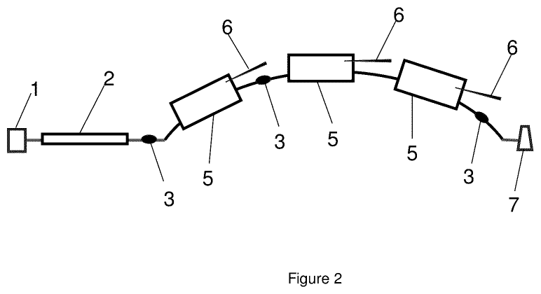

A first embodiment of the envisioned photon source is illustrated in FIG. 2. An electron beam generated by a photo-cathode injector 1 is accelerated by a Superconducting Radio-Frequency (SRF) linear accelerator 2 to the desired multi-GeV energy for production of soft to hard X-ray FELs. The electron beam is made of electron bunches 3 which are compressed to a very short length to attain ultra-high intensity and bunch current. These electron bunches are fed to a group of FEL oscillators (FELOs) 5 arranged serially along a line to produce coherent photon beams 6 in each of these devices. These FEL oscillators are all set in a low gain parameter regime. After passing through all the undulators while amplifying the radiation field in the optical cavities, the used electron bunches are sent to a dump 7.

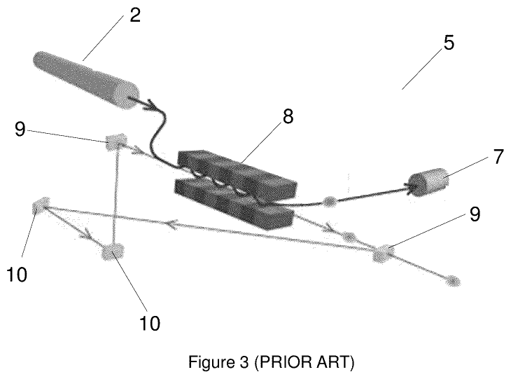

With reference to FIG. 3, one possible arrangement of a conventional FEL oscillator (FELO) 5 includes an electron accelerator 2 generating an electron beam that is directed through an undulator 8. X-rays are produced by electron beams propagating through Bragg reflecting crystal mirrors 9 creating an X-ray free electron laser (XFELO) 5. Additional mirrors 10 can be used for focusing and correcting the path of the electron beam.

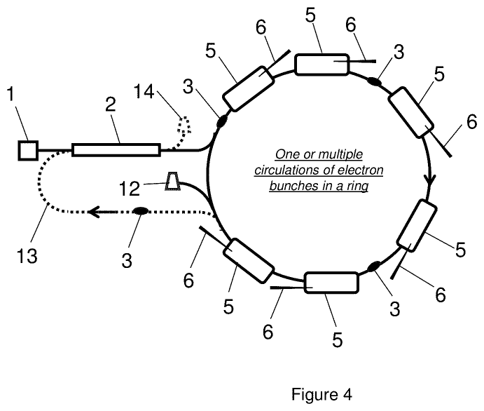

With reference to FIG. 4, depicting a second embodiment of a multi-FEL photon source, this invention enables creation of highly efficient and compact laser photon sources in which multiple FELOs 5 are distributed in a closed ring. An electron beam circulates in the ring a single turn or multiple turns to drive the FEL oscillators to generate lasers 6. Optional recovery of the used electron beam energy by the same accelerator, before the beam is sent to a used electron beam dump 12, is also depicted for high beam power operation. An optional beam line for energy recovery 13 (dashed line) may be used along with a used electron beam dump 14 after energy recovery. A high brightness electron beam from an accelerator 2 circulates in the ring a single or multiple times to drive all FEL oscillators 5 to generate high brightness coherent radiations 6. After the circulations, the used electron bunches are ejected out of the ring, and are either sent directly to a beam dump 12 or sent back to the accelerator for energy recovery before being dumped. Applying this ring-type design, a facility utilizing a high power and high brightness electron beam of multi-GeV energy could generate multiple (three to dozens) of high power hard X-ray FEL (XFEL) beamlines with photon energies 5-15 keV and above (i.e., 0.2-0.1 nm or shorter wavelength). The number of X-ray FEL beamlines and their brightness could exceed performance of present state-of-art FEL facilities.

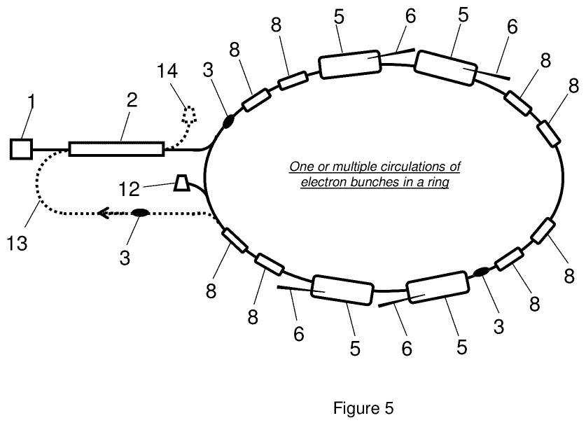

Referring to FIG. 5, the present invention enables creation of an advanced hybrid photon source facility which consists of both multiple FEL beamlines 6 produced by a set of serially arranged FEL oscillators 5, and multiple ultra-bright incoherent synchrotron radiation beamlines generated in conventional wigglers and undulators 8, all of these photon beamlines are driven by a single high brightness high average power electron beam. The electron bunches circulate once or multiple turns in the ring while generating both FELs and incoherent synchrotron radiations, then are sent to a dump 12. Recovery of energy of the used electron beam is required for high electron current operation by utilizing a return beamline 13.

Using a single electron beam without splitting and arranging multiple FELOs in a serial form, leads to several important advantages including a more efficient use of expensive electron beam from a high energy accelerator, superior average beam current, higher laser pulse repetition rate, the ability to accommodate a large number of FEL beamlines, increased compactness of multi-FEL facilities, and integration of FELs and incoherent synchrotron radiation beamlines.

The FEL beamlines presented herein are a novel application of the FEL oscillator concept which has been well-studied in the last twenty years. At very short wavelength of X-ray, high reflectivity Bragg crystals are utilized for making an optical cavity to amplify radiation intensity. Note that the term XFEL as used herein refers to FELs with wavelength similar to x-rays. The method of this invention is not limited to such short wavelengths; it can also be applied to longer wavelengths.

A key feature of the current invention is that these FEL oscillators are lined side-by-side (i.e., in a serial arrangement) so that electron bunches are passed through them one by one while generating FELs. Avoiding splitting of the electron beam effectively boosts the average current and power of the driving beam in the undulators of all FEL oscillators.

The underlying physics of the concept of serial arrangement of undulators and multi-time reuse of a driving electron beam is as follows. FELO is a small-gain free electron laser wherein the radiation fields are built up slowly through many round trips in an optical cavity. Therefore, the backreactions, namely interaction of the radiation fields on electrons, are much weaker. As a consequence, perturbation on electrons (distortion of electron bunch phase space distribution for example) over each pass of an individual undulator is small. This fact suggests these lightly used electron bunches could be undegraded enough for driving the next FEL oscillators in line. With a proper design of the magnet lattices and optics, and choice of the right beam parameters, the electron bunches could be reused multiple times before being sent to a dump. There will be a small reduction of FEL gain for used bunches due to backreactions, but that could be compensated by lower losses in the optical cavity, it may also take more rounds of the radiation pulse in the optical cavity. Eventually the radiation fields will reach a similar level of intensity at saturation since the latter is determined by a balance of gain in the undulator and combined loss of reflective crystal mirrors and radiation outcoupling.

When an electron bunch circulates in a ring, incoherent synchrotron radiation will damp bunch phase space property, eventually reducing it to an equilibrium state in phase space over several damping times. For a ring consider here and beam energies of X-ray FEL production, radiation damping time is typically several thousand circulations in the ring. The time over a few circulations in the ring is two to three orders of magnitude smaller than the electron damping time, thus the electron beam is still in the linac regime. Of course, the small beam degradation over each circulation should be taken into account in estimation of FEL gain.

Referring to FIG. 4, the second embodiment of the multi-FEL photon source according to the invention would include a group of FEL oscillators distributed in a closed ring in a serial arrangement. Instead of discarding the electron beam after one complete cycle for one pass of all the FEL undulators, the electron beam circulates multiple times in the ring for reuse, thus the average electron beam current is multiplied. With this feature, the average beam current and power in any individual FEL oscillator can be increased by a factor of kin, where k is number of FEL oscillators in the ring and n is number of bunch circulations. Thus, total photon flux (and average brightness) of every FEL beamline is boosted, to the 1^{st} order, by a same factor as the average beam current. A super photon source such as this could meet the user community's demand for very large number of FEL beamlines, and it could be realized only by application of the novel concept proposed by the current invention.

Referring to FIG. 5, in the third embodiment of the envisioned advanced photon source, both FEL oscillators and conventional undulators and wigglers are distributed in a closed ring. In this hybrid photon source driven by a single electron beam, the FEL oscillators will generate FEL beamlines, At the same time the wigglers and undulators are responsible for production of multiple high brightness incoherent synchrotron radiations. This design feature can also be combined with multi turns of recirculation in the ring to boost photon source performance, attaining an ultimate performance of an advanced photon source.

In the following, as illustrative examples, there are presented machine parameters and performance of two hybrid photon sources of both X-ray FEL oscillators and ultra bright incoherence synchrotron radiations driven by electron beams of different energies.

### FEL Performance

Table 1 lists the main parameters of a hybrid photon source according to the present invention. The hybrid photon source includes a ring of 1265 m circumference for a 5.7 GeV beam energy, assuming 4 FEL oscillators 5 in the ring as shown in FIG. 5. A straight for a single FEL oscillator is 50 m longer than these for incoherent synchrotron radiation beamlines. The ring would preferably include 39 circulating electron bunches; in each turn two of them will be replaced with fresh ones from the accelerator. The bunch spacing is 32 m, thus there are multiple photon pulses in the optical cavity to match the electron bunch train, boosting X-ray FEL pulse frequency to 9.24 MHz, similar to pulse frequency of a typical storage ring based conventional light source. For a 7.9 GeV electron beam energy, the ring circumference will be a little larger.

TABLE 1
Ring Parameters

| Electron energy | GeV | 5.7 | 7.9 |
|---|---|---|---|
| Ring circumference | m | ~1265 | ~1514 |
| Bunches in ring | | 39 | 21 |
| Bunch repetition rate | MHz | 9.24 | 4.16 |
| Bunch spacing | μs/m | 0.11/32 | 0.24/72 |
| Bunches replaced per turn | | 2 | 2 |
| Ratio of beam stored time | | ~0.28% | ~0.42% |
| and damping time | | | |
| Beam average current | mA | 3.51 | 1.28 |
| Beam average power | MW | 20 | 10 |

Table 2 summarizes parameters of a linear SRF accelerator as a full-energy injector to the main ring of the hybrid photon source in the X-ray FEL production mode. Since electron bunches circulate 10 or 20 times in the ring, the bunch repetition rate of the injection electron beam is much smaller, which enables not only large bunch charges but also dual operation of the photon source and other scientific program.

TABLE 2
Parameters of a Linear Accelerator as a
Full Energy Injector for FEL Operation

| Electron energy | GeV | 5.7 | 7.9 |
|---|---|---|---|
| Bunch repetition rate | MHz | 0.462 | 0.416 |
| Bunch spacing | μs/m | 2.2/649 | 2.4/721 |
| Beam average current | mA | 0.176 | 0.128 |
| Beam average power | MW | 1 | 1 |

Table 3 shows the estimated X-ray FEL performance. The transverse emittance and energy spread are slowly degrading along with bunch circulation due to incoherent synchrotron radiations in the bending dipoles of the ring. Thus, beam parameters in the table are given right after injection and also before ejection. The FEL gain for a fresh bunch and for a bunch in the last circulation are given in the table, providing a gain range for a bunch in different circulation. There is gain reduction as bunches are getting older. This result provides one of the key criterions for determining an optimal number of circulations. For the two cases presented here, ten circulations seem feasible.

TABLE 3
X-ray FEL Beam Parameters and Performance

| Electron energy | GeV | 5.7 | 7.9 |
|---|---|---|---|
| Wavelength | Å | 1.6 | 0.84 |
| Photon energy | keV | 7.74 | 14.7 |
| Electron bunch charge | pC | 380 | 310 |
| Electron bunch length, RMS | Ps | 0.25 | 0.25 |
| Peak current | A | 645 | 527 |
| Emittance (i to e) | μm rad | 0.3-1.1 | 0.37-1.3 |
| Energy spread (i to e) | 10⁻⁴ | 0.3-5 | 0.5-3.2 |
| FEL gain | | 46-6.4 | 12-0.54 |
| Peak radiation power | GW | 6.1 | 6.9 |
| Average radiation power | kW | 33.4 | 16.9 |
| Peak brightness | 10³⁴ Un | 1.6 | 1.1 |
| Average brightness | 10²⁸ Un | 8.9 | 2.8 |
| Spectrum purity | 10⁻⁷ | 4.6 | 1.7 |

Where Un stands for ph/s/0.1% BW/mm²/mrad²

The FEL performance is outstanding, delivering hard X-rays with higher than 10³⁴ ph/s/mm²/mrad²/0.1% BW peak brightness. The meaning of the term “hard X-rays” refers to X-rays with photon energies above 5-10 keV (wavelengths below 0.2-0.1 nm or 2-1 Å). The average brightness of each beamline is higher than 10²⁸ ph/s/mm²/mrad²/0.1% BW which is roughly three orders of magnitudes higher than in the present state-of-art LCLS-II (Linac Coherent Light Source II at Stanford National Accelerator Laboratory, Stanford University, Menlo Park, CA). The undulator for this estimation has 1500 periods, the width of each period is 1.88 cm and K=1.5. The total reflective loss of the optical cavity is assumed to be 20%, and the output coupling of the radiation field is 4%. Performance for both energy cases are quite similar.

### Incoherent Synchront Radiation Performance

During FEL production, the high bunch charge ultra-short bunches from the accelerator could also generate superior incoherent synchrotron radiation (SR) beams at the insertion elements that are installed for SR beamlines. As shown in Table 4, the peak brightness of SR beamlines could exceed 10²⁵ ph/s/mm²/mrad²10.1% BW, which is about 1000 times brighter than the Advanced Photon Source-Upgrade (APS-U), a 4^{th} generation photon source at Argonne National Laboratory, Chicago, IL. The average brightness is comparable to that of a storage ring source. Both FEL based and incoherent SR based experiments can be carried out simultaneously.

TABLE 4
Incoherent Synchrotron Radiation Generated
by FELO-type Electron Bunches

| Electron energy | GeV | 5.7 | 7.9 |
|---|---|---|---|
| Peak brightness | 10²⁵ Un | 1 | 2.8 |
| Average brightness | 10²⁰ Un | 0.53 | 0.57 |
| Pulse length | fs | 250 | 250 |
| Pulse repetition rate | MHz | 9.24 | 4.16 |
| Undulator | m | 3.6 | 3.6 |

Where Un stands for ph/s/0.1% BW/mm²/mrad²

In summary, the novel features of the present invention include the multiple use of driving electron bunches, the serial arrangement of multiple FEL oscillator apparatuses, and the application of circulator rings and/or energy recovery by accelerators. The advantages include more efficient use of electron beams from the accelerator, superior average current of a driving electron beam, the ability to accommodate a large number of FELO beamlines, increased compactness of multi-FEL facilities, and integration of FEL and incoherent synchrotron radiation.

As the invention has been described, it will be apparent to those skilled in the art that the same may be varied in many ways without departing from the spirit and scope thereof. Any and all such modifications are intended to be included within the scope of the appended claims.

I claim:

1. A method for efficient production of multiple high-brightness FEL beamlines using only one electron beam, comprising:
a group of serially arranged FEL oscillators arranged side-by-side along a line; and
passing electron bunches from an accelerator through all of said FEL oscillators to generate one FEL beamline in each of the FEL oscillators.

2. The method of claim 1, comprising:
said group of serially arranged FEL oscillators boosting the electron beam current by a factor of the number of FEL oscillators; and
leading to multiple times higher photon flux/average brightness.

3. The method of claim 2, comprising:
said group of serially arranged FEL oscillators arranged in a closed ring; and
said electron bunches from an accelerator passing through all FEL oscillators one time to generate an FEL beamline at each of said FEL oscillators.

4. The method of claim 3, comprising:
boosting the electron beam current by a factor of the number of serially arranged FEL oscillators; and
multiplying the amount of bunch recirculation in the ring and leading to multiple times higher photon flux/average brightness.

5. The method of claim 4, comprising combining electron bunch recirculation in the ring with reuse of the electron beam for energy recovery linac (ERL) for enhanced FEL production.

6. The method of claim 5, comprising said ring photon source includes a plurality of incoherent synchrotron radiation (SR) beamlines.
